(19) United States
(12) Patent Application Publication
(10) Pub. No.: US 2003/0130873 A1
(43) Pub. Date: Jul. 10, 2003

(54) Health care provider information system

(76) Inventors: William S. Nevin, Tucson, AZ (US); Susan K. Wortman, Tucson, AZ (US); James C. Wysocki, Tucson, AZ (US)

Correspondence Address: Robert Platt Bell, Registered Patent Attorney, 8033 Washington Road, Alexandria, VA, 22308, US

(21) Appl. No.: 09/988,234

(22) Filed: Nov. 19, 2001

(51) Int. Cl. G06F 17/60

(52) U.S. Cl. 705/3

(57) ABSTRACT

A method for gathering medical information sorting it by statistically and medically based rules, and condensing it into a data set which enables medical providers to practice medicine in a more efficient manner. The medical information may be gathered from insurance billing records and patient responses to statistically-validated medical status questionnaires. The patient population may be a defined one, being composed of all patients in a group which is being treated by an individual medical provider or a group of providers at any particular time. The financial transactions to be monitored may be formatted electronically into one or more standard formats as well as medical diagnosis and medical procedure information which has been transmitted in standard codes. These data sets are gathered in electronic format by being copied from the feeder computer system into another computer which does the required rules-based data reduction.

### FIELD OF THE INVENTION

The present invention relates to medical information systems. In particular, the present invention is directed toward a computerized method for gathering medical information, sorting it by statistically and medically based rules, and to condense it into a data set which enables medical providers to practice medicine in a more efficient manner.

### BACKGROUND OF THE INVENTION

Maintaining patient medical records can be a difficult task. Patients move from place to place, change doctors and medical plans, and thus create multiple records in multiple offices. Prior Art patient files or charts were typically hand-written, requiring an inordinate amount of storage space and file organization. As such, inactive charts may be archived or destroyed after a predetermined amount of time. A patient may find it difficult to maintain a complete medical record, as incomplete files may exist.

Attempts have been made to computerize patient charts. However, since most Prior Art charts were handwritten, efforts to computerize these charts met with limited success. Attempting to keypunch notoriously illegible doctor handwriting is difficult at best. Moreover, patient chart data may be in a non-standardized format and difficult to computerize. As such, a computerized version of the Prior Art patient chart may require significant amounts of storage space, requiring archiving or destruction of inactive data in a similar manner to paper charts.

Moreover, merely computerizing patient chart data may not take the best advantage of computer system capabilities—namely the ability to spot trends and anomalies in data. Merely taking a paper data product and making it electronic does little to enhance the value of the underlying product.

In recent years, costs associated with health care have been rapidly increasing. A variety of systems which utilize various computer hardware and software have been developed in an effort to simplify and expedite the processing of claims relating to health benefits. Furthermore, various methods have been devised to try to contain and control the rising costs. However, these systems are more related to cost control and insurance billing than toward maintaining patient records.

One such system is illustrated in Tawil, U.S. Pat. No. 5,225,976, issued Jul. 6, 1993, entitled “Automated Health Benefit Processing System” and incorporated herein by reference. This system utilizes a database having the benefits payable to an insured if the procedure is prescribed and performed by one of the available providers. Through the use of three processors, the medical procedure to be performed is selected, the treatment is actually performed by the provider, the provider's charges are input, and the treatment plan, treatment records, and amounts payable are calculated.

Mohlenbrock et al., U.S. Pat. No. 5,018,067, issued May 21, 1991, entitled “Apparatus and Method for Improved Estimation of Health Resource Consumption Through Use of Diagnostic and/or Procedure Grouping and Severity of Illness Indicators” and incorporated herein by reference discloses a computer software system for estimating the cost to treat a patient, based upon the condition of the patient, and to the extent that any treatments or procedures impact the patient's health status. The system uses the same information that is used as a basis for determining the Diagnostic Related Groups (DRGs).

Clinical information is extracted by the Resource Estimating System from the International Classification of Diseases, 9th Revision, Clinical Modification (ICD-9-CM, incorporated herein by reference) codes and other available input data in order to make an estimate. Other codes may also be used without departing from the spirit and scope of the present invention. For example, DSM-III-R, provided in “Diagnostic and Statistical Manual of Mental Disorders,” 3rd Edition, Revised (Washington, American Psychiatric Association, 1987, incorporated herein by reference) may be applied in a mental health environment.

The data is combined by the computer according to a formula that includes a set of constants for each DRG and which provides for variables depending upon each actual patient. The output provides a comparison on the basis of a homogeneous patient population to identify those providers whose practice patterns are of the highest quality and most cost efficient. Furthermore, the expected cost of treating a patient may be determined.

Cummings, Jr., U.S. Pat. No. 5,301,105, issued Apr. 5, 1994 entitled “Allcare Health Management System” and incorporated herein by reference, discloses an integrated and comprehensive health care system which includes the interconnection and interaction of a patient, health care provider, bank or other financial institution, insurance company, utilization reviewer, and employer so as to include within the system all the participants to provide patients with complete and comprehensive health care and the financial system to support it.

Barber et al., U.S. Pat. No. 4,858,121, issued Aug. 15, 1989 entitled “Medical Payment System” and incorporated herein by reference, discloses a system in which remote computer terminals are placed in the physician's office. These are connected by telephone lines with a central processing system. The data which is entered at the terminal is processed to incorporate previously stored data. The central processing computer processes the received data and formats it into a form for filing medical claims to the insurance company.

Through an electronic funds transfer system, the funds are transferred directly to a patient's account and receipt of funds from the insurance company is acknowledged. Again, this system, as those previously disclosed, does not provide any incentive for providers to consult to minimize unnecessary procedures nor does it provide for payment of funds from a pool of funds over a predetermined time period.

The aforementioned systems all have one thing in common—they appear to be more concerned with payment for services than in maintenance of medical records. Systems are known in the art for maintaining and generating patient medical records, however, these systems, as noted above, have their own limitations.

Strum et al., U.S. Pat. No. 5,842,173, issued Nov. 24, 1998 and incorporated herein by reference, discloses a computer-based surgical services management system. This system appears to generate a patient record including classes of patients, locations, resources, surgeons, and anesthesiologists. The system appears to be limited to surgical services sites and does not appear to be an overall patient health record maintenance system. Strum appears to claim to automate the process of inputting patient data. However, it appears the system is limited to use on a network, where data follows a patient from location to location in a surgical services facility, with data stored locally on PCs at the patient's location.

It does not appear that Strum contemplates a global patient database containing all of patient history from a number of external sources. Rather, it appears that the Strum system is used only internally within a surgical facility (e.g., hospital) to schedule patients, doctors, and equipment, as well as follow-up visits. Since surgeries account for only a portion of health care services, the system of Strum does not appear to maintain or provide a complete patient history.

Singer, U.S. Pat. No. 6,304,848, issued Oct. 16, 2001 and incorporated herein by reference, discloses a medical record forming and storing apparatus and method. This system appears to be an attempt to computerize what were formally written medical records. Using a rather complicated speech recognition apparatus, Singer uses vocal inputs from a doctor to create patient records. In addition to the problems still inherent in speech recognition, the system still requires manual intervention by a doctor. Data is not automatically generated or combined. Moreover, such data, when computerized, may not lend itself well to computerized analysis and trend interpretation.

Thus, it remains a requirement in the art to provide a system for generating and maintaining patient medical records which may be readily interfaced with existing sources of medical data, and may generate accurate and compete patient medical data in a compact format.

It also remains a requirement in the art to provide a patient medical data system which can analyze patient data to determine whether additional treatments are necessary and/or to identify patients on a particular disease track and recommend treatment and/or education.

It remains a further requirement in the art to provide a patient medical data system which may provide patient data reports in formats customized for doctor, patient, and health care provider.

### SUMMARY OF THE INVENTION

A system and method are provided to gather medical information, to sort it by statistically and medically based rules, and to condense it into a data set which enables medical providers to practice medicine in a more efficient manner. The medical information may be gathered from insurance billing records and patient responses to statistically-validated medical status questionnaires. The patient population may be a defined one, being composed of all patients in a group which is being treated by an individual medical provider or a group of providers at any particular time. It can also be a group of employees, or their dependents, for whom their employer pays the majority of their medical services cost. In this case, the employer is the primary entity at risk for the cost of medical care.

A group of patients may typically comprise people for whom the provider has contracted with one or more insurance companies to provide medical services. The financial transactions to be monitored may be formatted electronically into one or more standard formats (typically UB92 or HCFA-1500 formats). Data may be obtained from a claim submission form such as a Health Care Financing Administration (HCFA-1500) standard health insurance claim form. Alternatively, the information can be obtained from a form UB-92 which is the 1992 revision of the Uniform Billing Medicare Insurance Claim Form. Alternatively, the information can be obtained from electronic data input.

In addition, data may be obtained from medical diagnosis and medical procedure information which has been transmitted in standard codes (i.e., in one or more of ICD-9, CPT-4, DRG, APC, and/or HCPCS formats). ICD-9 has been previously mentioned. CPT-4 is provided in “Physicians Current Procedural Terminology,” Fourth Edition, developed and revised by Department of Coding and Nomenclature, American Medical Association and incorporated herein by reference. DRG has been previously mentioned. CPT-4 codes are presented in “AMA Physicians' Current Procedural Terminology CPT 97,” CPT Intellectual Property Series, Chicago, Ill., 1996, which is incorporated herein by reference for all purposes.

Additional terminology coding may include: Code it Right Techniques for Accurate Medical Coding, published by Medicode Inc., HCPCS 1994 Medicare's National Level II Codes, published by Medicode Inc., Med-Index ICD 9 CM Fourth Edition 1993, published by Med-Index, each of which is hereby incorporated by reference in its entirety for the material disclosed therein. Other examples of patient condition codes which may be utilized by the present invention include ICCS codes, ICD-8 codes, ICD-10 codes and the like, all of which are incorporated herein by reference.

These data sets may then be gathered in electronic format by being copied from the feeder computer system into another computer which does the required rules-based data reduction.

Patient status information may be gathered in an interview using Short Form 36 (or SF-36), a nationally validated and normed test instrument. The answers provided may be put into electronic form and correlated with the diagnosis and procedural treatment results according to a specific set of rules. The resultant information may be organized into a unique presentation which allows medical providers to practice medicine in a more efficient manner.

Information may be gathered from computer files or independent or networked computer systems and personal data assistants. The resultant data may then be transmitted to a data reduction center via a secure, encrypted computer network connection using an internet or intranet network path.

### BRIEF DESCRIPTION OF THE DRAWINGS

FIG. 1 is a flowchart illustrating the overall process of the present invention.

FIG. 2 is a detail flowchart of the process labeled A.1 in the flowchart of FIG. 1.

FIG. 3 is a detail flowchart of the process labeled A.1.1 in the flowchart of FIG. 2.

FIG. 4 is a detail flowchart of the process labeled A.2 in the flowchart of FIG. 1.

FIG. 5 is a detail flowchart of the process labeled A.3 in the flowchart of FIG. 1.

FIG. 6 is a detail flowchart of the process labeled A.4 in the flowchart of FIG. 1.

FIG. 7 is a detail flowchart of the process labeled A.5 in the flowchart of FIG. 1.

FIG. 8 is a detail flowchart of the process labeled A.6 in the flowchart of FIG. 1.

FIG. 9 is a detail flowchart of a first part of the process labeled A.7 in the flowchart of FIG. 1.

FIG. 10 is a detail flowchart of a second part of the process labeled A.7 in the flowchart of FIG. 1.

FIG. 11 is a detail flowchart of the process labeled A.8 in the flowchart of FIG. 1.

FIG. 12 is a detail flowchart of the process labeled A.9 in the flowchart of FIG. 1.

FIG. 13 is a detail flowchart of the process labeled A.10 in the flowchart of FIG. 1.

FIG. 14 is a detail flowchart of the process labeled A.11 in the flowchart of FIG. 1.

FIG. 15 is a block diagram illustrating various hardware elements of the present invention as coupled by a virtual private network, using the internet or world wide web.

FIG. 16 is a screen image of a login procedure for the system of the present invention.

FIG. 17 is a screen image illustrating a welcome page and menu of the present invention.

FIG. 18 is a screen image illustrating a selected list of patients.

FIG. 19 is a screen image of a Health Summary Record for a selected patient.

FIG. 20 is a screen image of a patient search engine data input screen.

FIG. 21 is a screen image of patients by diagnosis report generation input screen.

FIG. 22 is a screen image of a result of a patient diagnosis report generated from the input of FIG. 21.

FIG. 23 is a screen image of a patient drug report generation input screen.

FIG. 24 is a screen image of the results of a patient drug report generated from the input of FIG. 23.

FIG. 25 is a screen image of a Health Summary report (HSR) generated by clicking on one of the name listed in FIG. 24.

FIG. 26 is a screen image of a input screen for linking to guidelines and protocols.

### DETAILED DESCRIPTION OF THE INVENTION

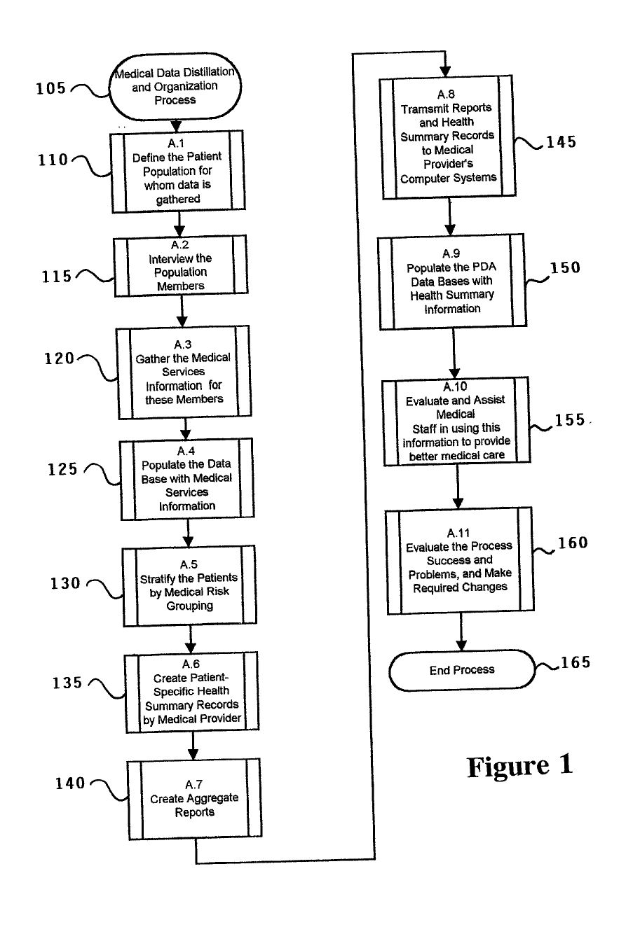

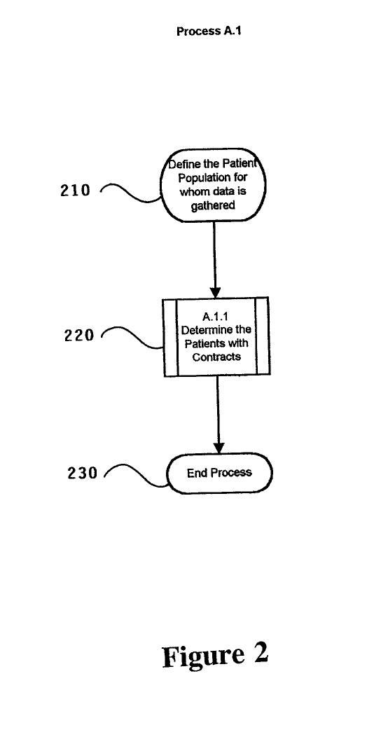

FIG. 1 is a flowchart illustrating the overall process of the present invention. The various processes in each step of the flowchart of FIG. 1 will be described in more detail in the accompanying flowcharts of FIGS. 2-14. For the sake of illustration, each process has been given a process number (A.1 though A.11) which is also referenced in the accompanying flowcharts of FIGS. 2-14.

In step 105, the process of distilling and organizing medical data is initiated. While illustrated here as a start-to-finish process in the context of a traditional flowchart, the actual process may be continuous once initiated, and each sub-process may actually run concurrently as well as sequentially. However, for the sake of illustration in understanding the present invention, the invention is illustrated here as a sequential flowchart.

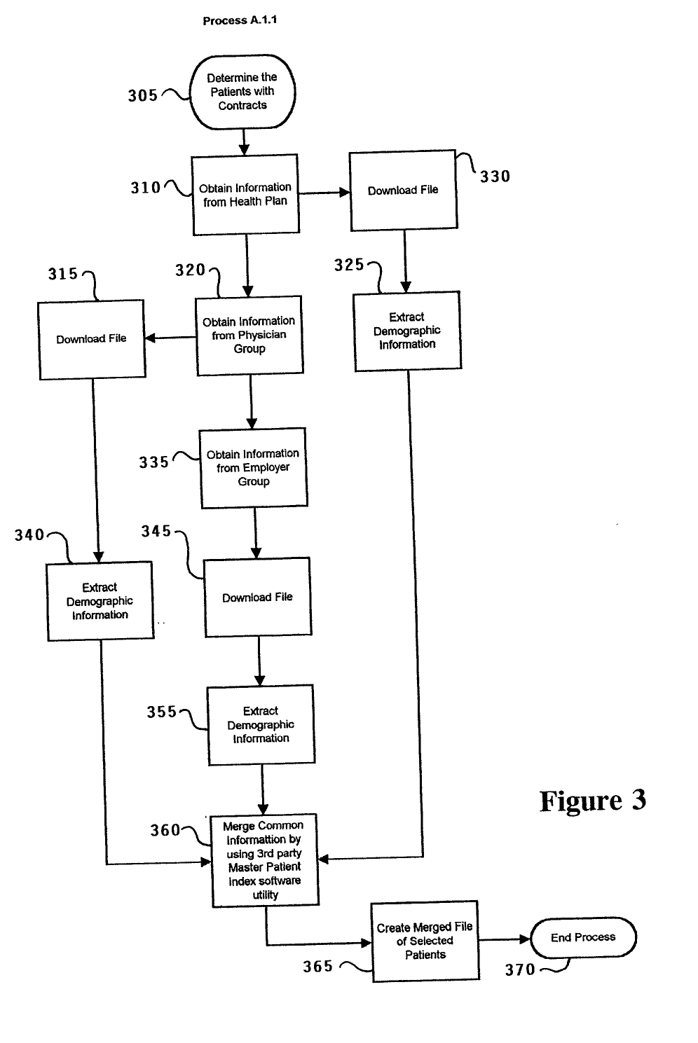

In step 110, process A.1 is executed. This process is illustrated in more detail in FIGS. 2 and 3. In this process, the Patient Population for whom data is to be gathered is defined. The patient population may be a defined one, being composed of all patients in a group which is being treated by an individual medical provider or a group of providers at any particular time. A group of patients may typically comprise people for whom the provider has contracted with one or more insurance companies to provide medical services.

Various parameters may be used to define a particular patient population, including patients using a particular health care provider (insurance company, PPO, HMO, or the like) , patients using a particular doctor or medical practice, patients working for a particular employer, or other definition information (e.g., geographic area, military status, veteran status, Medicare/Medicaid recipient, or the like).

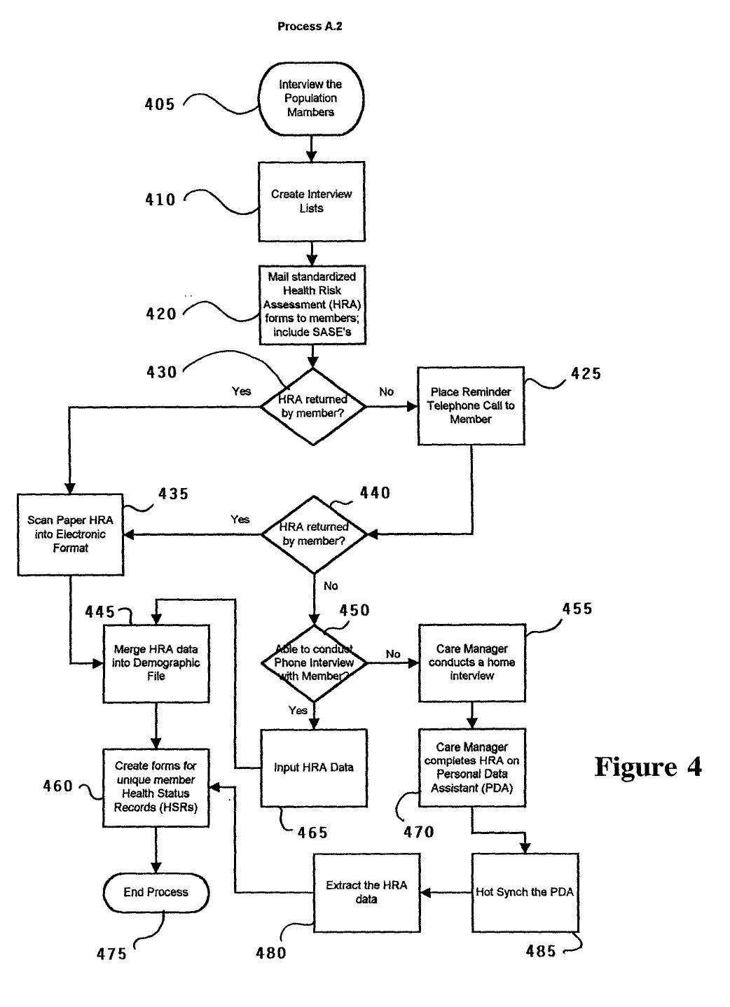

Once a desired target patient population has been defined, processing proceeds to step 115, process A.2, interview with patient population members. This process is illustrated in more detail in FIG. 4. In this process, baseline data may be obtained using industry standard patient interview forms such as the Health Risk Assessment (HRA) form or Short Form 36 (or SF-36), a nationally validated and normed test instrument.

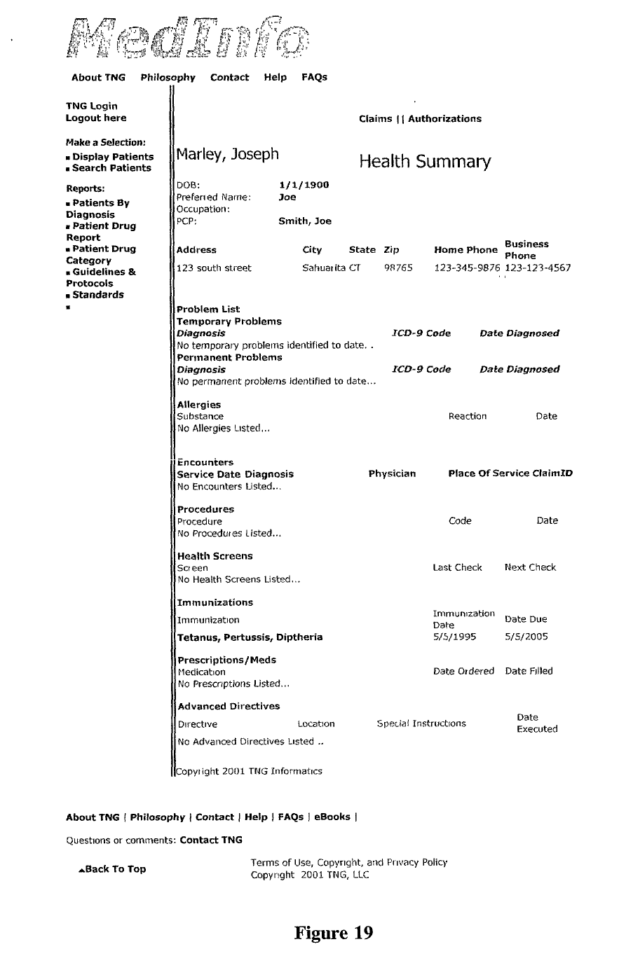

The answers provided may be put into electronic form and correlated with the diagnosis and procedural treatment results according to a specific set of rules, as will be discussed in more detail below. Alternately, the HRA or SF-36 forms may be provided to patients in electronic forms. A patient may fill out such a form using a PDA (Personal Digital Assistant) , computer terminal or PC (Personal Computer), or even over the Internet. Data from the HRA forms may be processed and merged with demographic data to create Health Summary Records (HSRs) forming the initial base of the patient database of the present invention. An example of an HSR format is illustrated in FIG. 19.

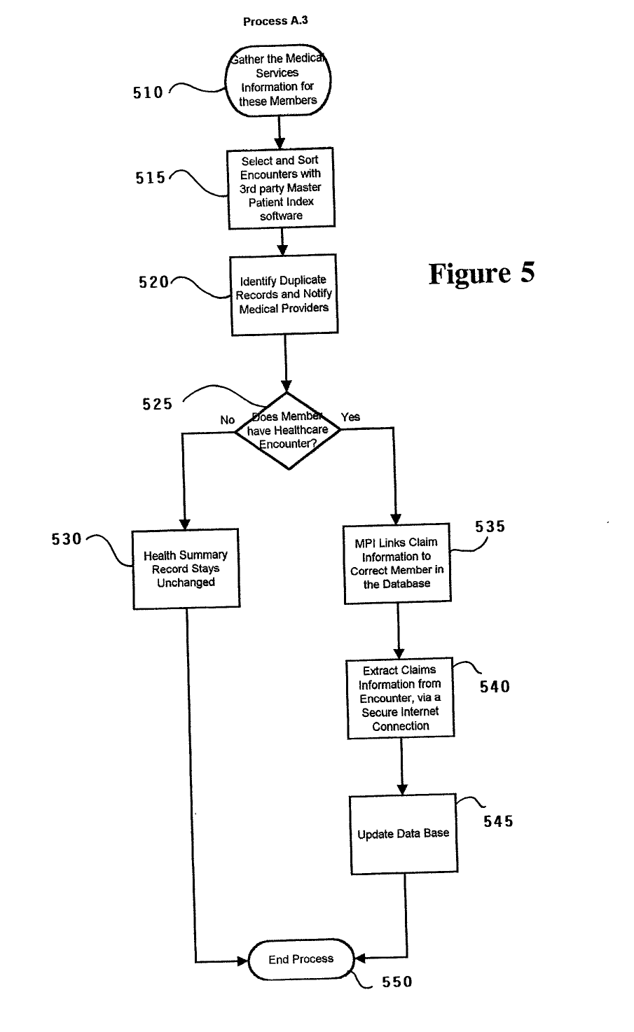

In step 120, process A.3, medical services information for each member may be obtained. This process is illustrated in more detail in FIG. 5. In this process, a determination is made as to whether a patient has had a healthcare “encounter”. Contact is made with the healthcare provider database, and “encounter” data (e.g., doctor or hospital visits resulting in a claim being made) is downloaded and integrated into the database of the present invention.

Particular formats for the Database(s) of the present invention may be varied, depending upon they types of patients treated and the data that a particular health care provider or medical center may wish to track. Examples of the database structures in the preferred embodiment of the present invention are illustrated in the APPENDIX attached to the present application. These database structures merely set forth the best mode contemplated at the time of filing of the present application and should in no way be construed as limiting the spirit and scope of the invention in any way.

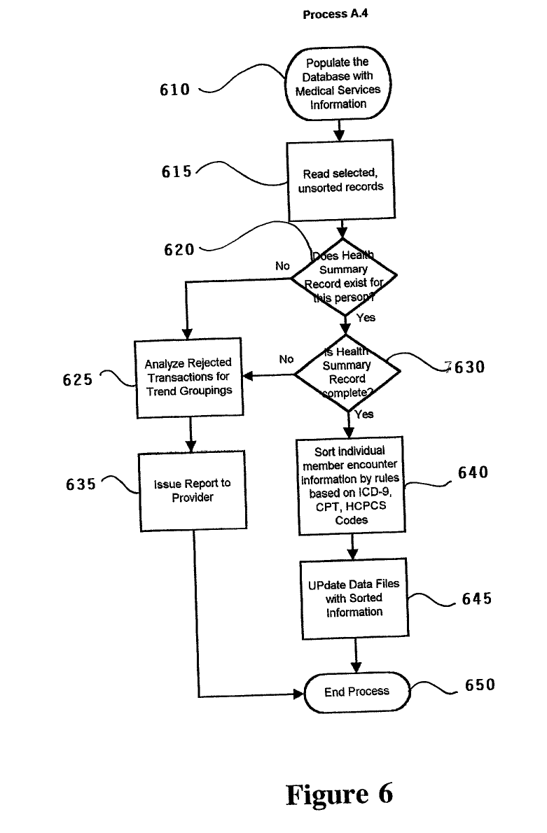

In step 125, process A.4, the database is populated with medical services information. This process is illustrated in more detail in FIG. 6. From the data gathered in the previous steps, medical reports may be generated for each patient (or groups of patients) using the data gathered from the patients, as well as the claim encounters. The database may then be updated with these reports and/or such reports may be generated to the provider.

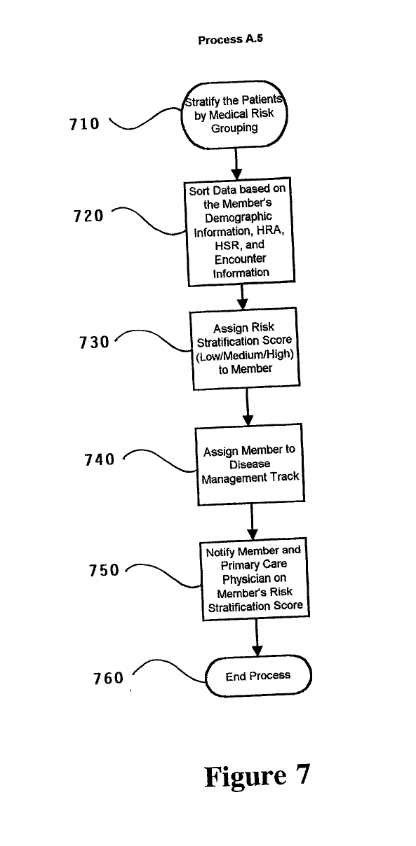

In step 130, process A.5, the patient database may be stratified on the basis of medical risk grouping. This process is illustrated in more detail in FIG. 7. In this process, each patient may be assigned a health risk “score” based upon the data from the previous steps (HRA, HSR, demographics, claim encounters). A member (patient) may be then assigned to a disease management track. In this manner, patients with a particular risk potential for a particular disease (e.g., diabetes, heart disease, cancer) may be “tracked” and preventative medicine practiced to prevent or delay the onset of such diseases.

Unlike Prior Art systems, which attempt only to manage or monitor expenditures after they have occurred, in the present invention, health care costs and patient health may be improved by identifying patients at risk early on. This change allows physicians to treat patients before minor medical problems become major ones.

For example, certain chronic diseases, such as diabetes, have known etiologies and associated risk factors. Guidelines for treatment have been promulgated by, e.g. the American Diabetes Association, the National Commission for Quality Assurance (NCQA) and Diabetes Quality Improvement Project (DQUIP). These guidelines incorporate known complications associated with diabetes such as retinopathy, neuropathy, nephropathy, Pulmonary Vascular Disease (PVD), Cardial Artery Disease (CAD) and cerebral vascular disease.

In addition to various tests associated with monitoring the diabetes, such as HbAlc (measuring glycosolated hemoglobin levels), microalbumin (blood protein), lipids (cholesterol), and the like, the physician must typically perform routine eye and foot examinations to monitor the progress of the disease. These tests are in conjunction with those examinations normally associated with an office visit, i.e. blood pressure, temperature, weight, pulse, and the like.

In addition, there is a significant education and behavior component to the treatment of the disease which can encompass such items as nutrition counseling, smoking cessation, and self education about the disease. The Center for Disease Control estimates that diabetes is reaching epidemic proportions in the United States. Effective treatment centers on the known parameters and risk factors associated with the disease, and insuring that the patient is meeting the objectives of the treatment plan. By assigning a patient to a disease management track, the patient can receive the necessary education, preventative care, and testing.

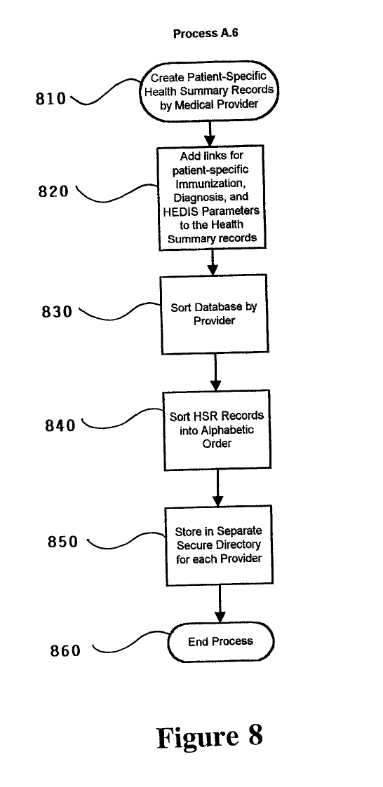

In step 135, process A.6, patient-specific health summary records may be created by the medical provider. This process is illustrated in more detail in FIG. 8. In this process, links may be added for patient-specific immunization, diagnosis and HEDIS parameters to the Health Summary Records.

HEDIS (Healthplan Employer Data and Information Set) serves as the clinical performance measurement and data repository for private and federal health-care buyers. HEDIS is a database of quality measures developed by NCQA and used as a standard evaluation tool for health plans. HSR records may then be sorted by provider, alphabetical order, and the like.

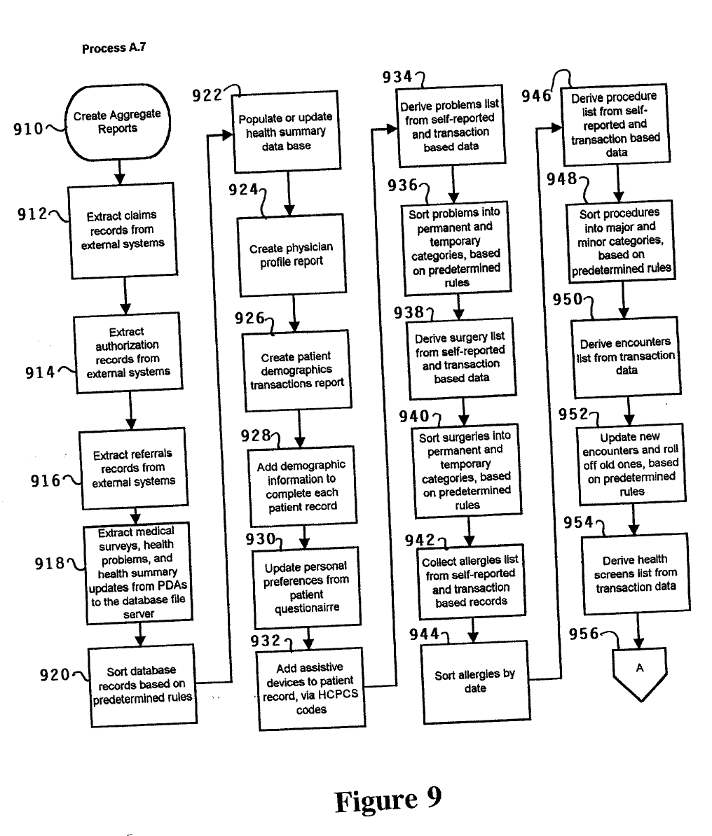

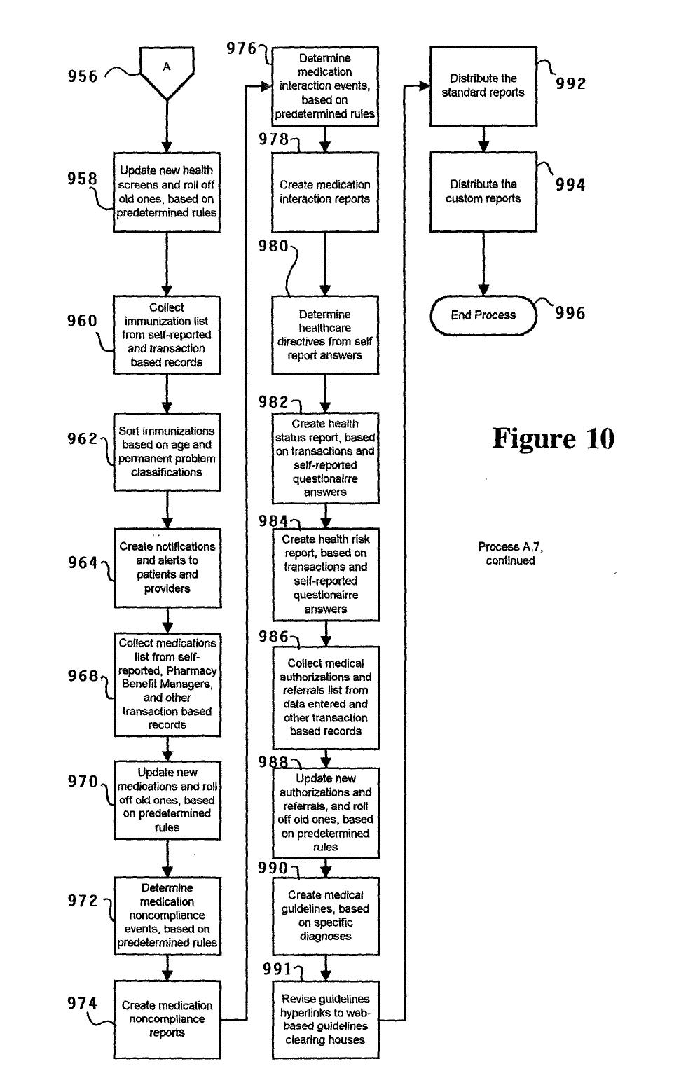

In step 140, process A.7, aggregate reports may be created. This process is illustrated in more detail in FIGS. 9 and 10. In this process, data may be gathered from the sources listed above, as well as physician PDA's to generate physician and other reports. Patient health data may be categorized into “permanent” or “temporary” categories. Permanent health data refers to ongoing or chronic conditions (e.g., diabetes, heart disease, allergies, and the like) which follows the patient for life or at least a significant period of time. Temporary conditions may refer to health incidents which are transitory in nature (e.g., broken bones, head cold, flu, and the like) which may not affect a patient's health in the long term.

As part of this report generation process, medication noncompliance reports may be generated. In many instances, patients may see a doctor for a health condition and receive a prescription for medication. However, in traditional practice, there is no technique for insuring that the patient actually purchases and takes the medication. In the system of the present invention, health insurance data (e.g., through pharmacy reimbursement or co-pay data) may be used to confirm that medicine prescribed by the doctor is actually purchased by the patient. If not, a report may be generated indicating that the patient did not follow the prescribed course of action. From such reports, follow-up calls may be made to the patient.

In addition, other types of reports may be generated, customized for the intended audience or user. Thus, for example, a first set of reports may be generated for physician use, a second set for health care provider (e.g., insurance company) use, and a third set for patient use. Patients may be able to access their own medical records via secure link or the like. Patient data may include more educational information such that if a patient is diagnosed with a particular illness or disease, appropriate educational information may be provided for that illness or disease in the patient report.

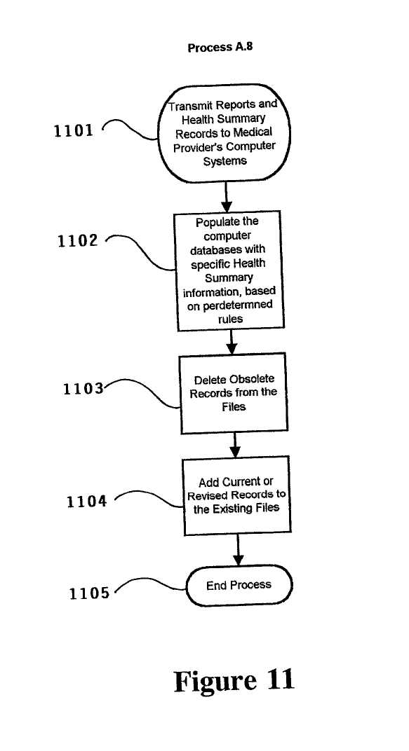

In step 145, process A.8, reports and HSR's may be transmitted to the medical provider's computer systems. This process is illustrated in more detail in FIG. 11. In this process, original records or copies of older or obsolete data may be deleted from the health care provider's files and updated data from step 140 stored, based upon the predetermined rules outlined above.

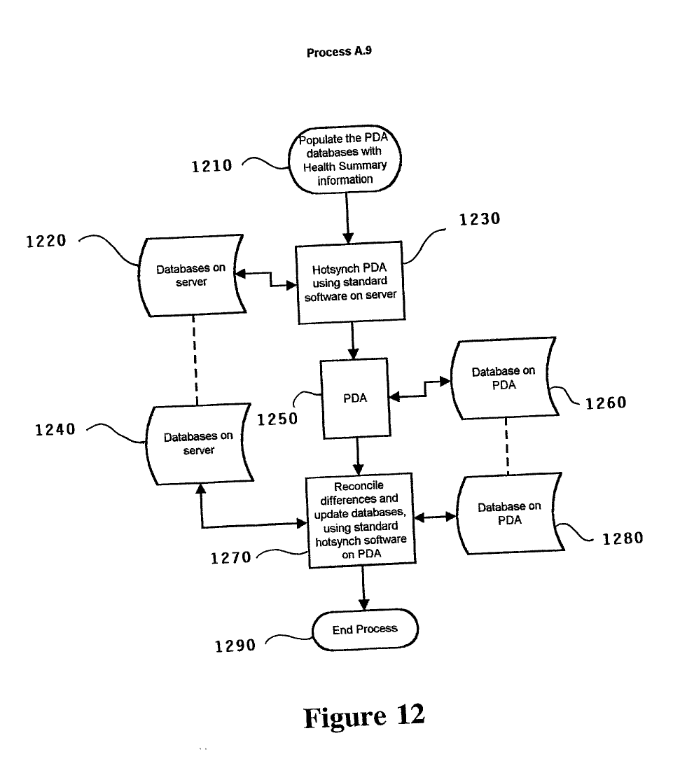

In step 150, physician PDA databases may be populated with HRS data. This process is illustrated in more detail in FIG. 12. In this process, Physician PDAs (Personal Digital Assistants) may be downloaded with updated patient information when they are “hot synced” with a base station (e.g., PC or the like). Differences between data on the PDA and data stored on different databases may be reconciled and updated. New data entered by a physician, for example, may be uploaded onto the databases. Newer data generated by the reporting functions may be downloaded to the PDA.

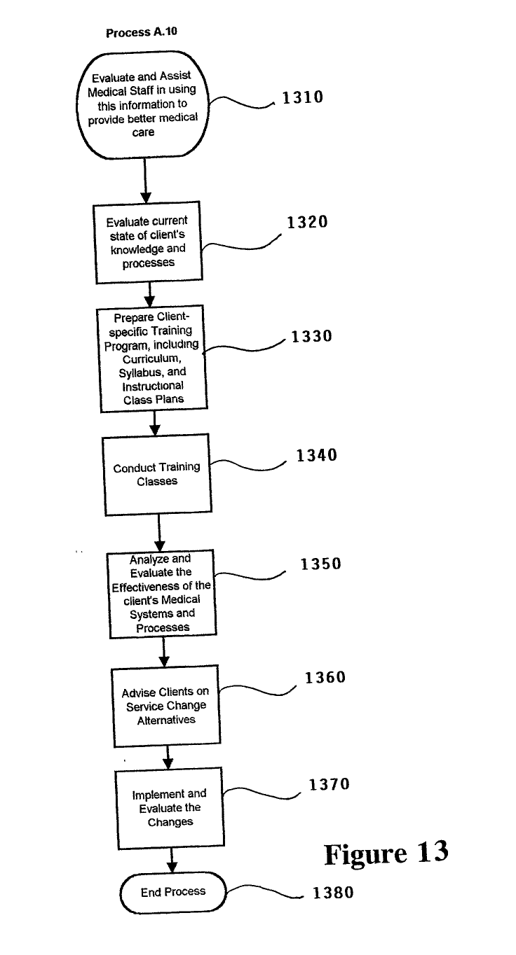

In step 155, process A.10, the data provided by the present invention may be used by medical staff to provide improved health care. This process is illustrated in more detail in FIG. 13. In the process of step 155, the client (e.g., service provider, medical center, doctor) may be evaluated and instructed into how the data of the present invention may be best employed.

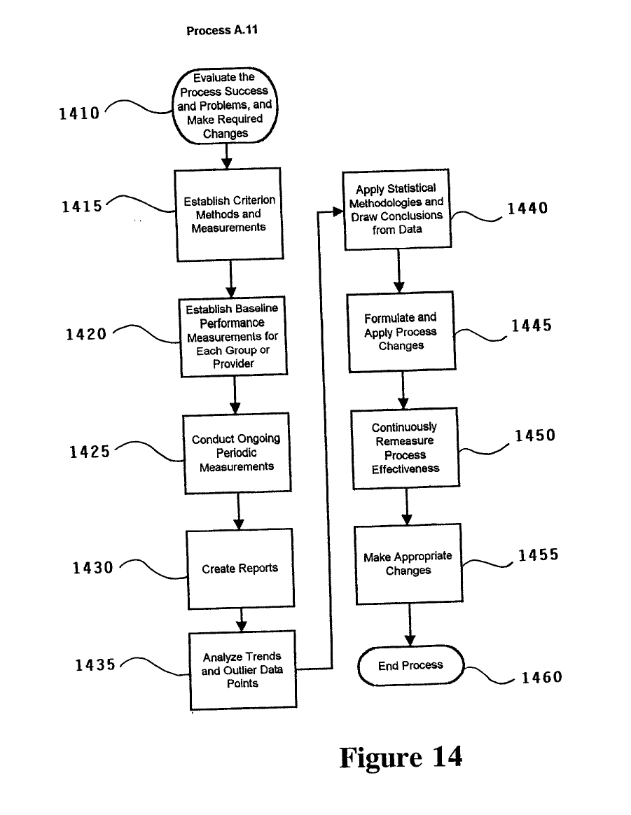

In step 160, process A.11, the system of the present invention may also be evaluated and altered to improve performance, response, and reliability. This process is illustrated in more detail in FIG. 14. In this process, the system of the present invention may be evaluated and refined to improve performance and service.

The various process steps of FIG. 1 will now be described in more detail in connection with FIGS. 2-14.

FIG. 2 is a detail flowchart of the process labeled A.1 in the flowchart of FIG. 1. In this process, the Patient Population for whom data is to be gathered is defined. In step 210, the process of defining the patient population for whom data is to be gathered commences. In step 220, process A.1.1, a determination of patients with health care contracts is made. FIG. 3 is a detail flowchart of the process labeled A.1.1 in the flowchart of FIG. 2.

In step 305, the process of determining patients with contracts commences. The patient population may be a defined one, being composed of all patients in a group which is being treated by an individual medical provider or a group of providers at any particular time. A group of patients may typically comprise people for whom the provider has contracted with one or more insurance companies to provide medical services.

In step 310, information is obtained from a health plan database. This information may include lists of patients insured by the health plan, participating doctors, hospitals, and medical groups, and other plan and patient data. In step 330, actual file data is downloaded and in step 325, demographic data for patients is extracted.

In step 320, information is obtained from a physician group database. This information may include lists of patients handled by each physician and other patient data. In step 315, actual file data is downloaded and in step 340, demographic data for patients is extracted.

In step 335, information is obtained from a database, such as that from an employer group, hospital, or any other source of a defined medical population. This information may include lists of employee patients for a particular employer insured by the health plan and other patient data. In step 345, actual file data is downloaded and in step 355, demographic data for patients is extracted.

In step 360, all sources of data are merged using a third party master patient index software utility. In this manner, a complete list of patients may be generated, and using multiple data sources, a complete background and demographic data (name, address, social security number, and other information) may be obtained. The use of multiple data sources insures that a complete data set is generated for each patient without the need for manually filling in missing data with calls to patients or the like.

Various parameters may be used to define a particular patient population, including patients using a particular health care provider (insurance company, PPO, HMO, or the like), patients using a particular doctor or medical practice, patients working for a particular employer, or other definition information (e.g., geographic area, military status, veteran status, Medicare/Medicaid recipient, or the like). Thus, in other applications, different data sources may be used than those illustrated in FIG. 3. For example, in a military application, military and/or veterans's records may be used in place of employment records. Similarly, if applied in a government environment (e.g., Medicare, Medicaid), government data sources may be used in place of, or as an augment to, employer data.

In step 365, a merged file of selected patients is created from the data generated in step 360. In step 370, the process is complete, and processing returns to FIG. 2, where the process is ended. Again, as noted above, this process may be ongoing, rather than a one-time operation. As patient populations are dynamic, the patient population definition routine may be run continuously, or periodically (e.g., weekly, monthly) to update the patient database.

FIG. 4 is a detail flowchart of the process labeled A.2 in the flowchart of FIG. 1. In this process, baseline data may be obtained using industry standard patient interview forms such as the Health Risk Assessment (HRA) form or Short Form 36 (or SF-36), a nationally validated and normed test instrument.

The answers provided may be put into electronic form and correlated with the diagnosis and procedural treatment results according to a specific set of rules, as will be discussed in more detail below. Alternately, the HRA or SF-36 forms may be provided to patients in electronic forms. A patient may fill out such a form using a PDA (Personal Digital Assistant), computer terminal or PC, or even over the Internet. Data from the HRA forms may be processed and merged with demographic data to create Health Summary Records (HSRs) forming the initial base of the patient database of the present invention.

In step 405, the population member interview process commences. In step 410 lists are created of population members (i.e., patients) to be interviewed. If patient interview data had already been entered or retrieved from another database, such patients may be excluded from the interview list. Patients who were previously interviewed may be re-interviewed after a predetermined period (e.g., every few years) to insure data is accurate and up-to-date.

In step 420, standardized Health Risk Assessment (HRA) forms are mailed to patients identified in the interview lists of step 410, together with a self-addressed, stamped envelope (SASE) for return by the patient. The forms may be coded for electronic entry. Alternately, patients may be allowed to fill out the forms electronically, either on-line over a secure internet link, or at a data terminal (computer terminal, PC, PDA, or the like) at a place of employment or at a doctor's office or medial facility.

In step 430 a determination is made whether the HRA was returned by the member or electronically entered. If not, a telephone call (or e-mail message or the like) may be made to the member to remind the member to complete the HRA. If the HRA is still not completed, as indicated in step 440, a determination is made in step 450 whether the HRA data can be obtained through a phone interview. If so, HRA data may be input by a phone operator or the like in step 465. If not, a care manager may conduct a home interview in step 455, completing the HRA form in step 470, for example, on a PDA.

If a PDA is used to accumulate HRA data, it may be hot synched in step 485, and data extracted in step 480. If a paper HRA form is used, it may be scanned electronically or keypunched (if necessary) in step 435. Regardless of data input method, HRA data may be merged into the demographic data file in step 445 and form for each unique member may be created as Health Summary Records (HSRs) in step 460. The process is completed in step 475.

As in the other steps of this process, the process of FIG. 4 may be ongoing. As new patients enter the system, HRA data may be retrieved. Similarly, as noted above, existing patients may be polled randomly or periodically to insure health data is up-to-date. In addition, patients for whom there is no activity (i.e., patients who may not be using the healthcare system for one reason or another) may be polled with HRA forms after predetermined periods of inactivity.

FIG. 5 is a detail flowchart of the process labeled A.3 in the flowchart of FIG. 1. In step 510, the process of gathering medical services information for each member commences. In step 515, each “encounter” is selected and sorted by a third party master patient index software. As used in the present invention, the term “encounter” refers to a billable incident in the healthcare system, even if this results in a transaction with no monetary amount being due. While other medical record system attempt to include all medical data for each patient (e.g., an electronification of doctor's files) in the present invention, only the HRS data and encounter data are used.

Data which does not result in a patient generating a billing event probably does not significantly impact the overall picture of a patient's health status. Moreover, non-encounter information may be difficult to obtain and take up an inordinate amount of memory and/or be difficult to categorize or quantify. Encounter information, on the other hand, is already coded using one or more of the numerous coding systems implemented in the industry as mentioned above. Thus, in the present invention, a complete patient data record may be generated efficiently from encounter information.

In step 520 duplicate records are may be identified and medical providers notified of such duplicate records. This housekeeping steps prevents patient records from being entered multiple times in the system and thus preventing an accurate picture of patient health from being generated. Duplicate records can be generated in billing software due to human or computer error. For example, if a patient's address changes, the patient may be entered on the system twice under new and old addresses.

In a billing environment, the presence of duplicate records (i.e., list hygiene) may not be critical. From the billing perspective, all that is important is that the patient is covered and the service provided and paid for is an insured service.

However, when using such encounter records to generate patient data, it may be critical to insure that duplicate records do not exist. If a patient is entered on the system in one entry for a first symptom, and entered as a separate patient on the system for a second symptom, it may be important for a doctor or health care provider to know that the patient is having both symptoms concurrently.

In step 525 a determination is made whether a particular patient has had an “encounter” (e.g., doctor, medical specialist, or hospital visits resulting in a claim being made). If not, the Health Summary Record (HSA) remains unchanged, as shown in step 530. If a new encounter has occurred, the system links the claim information to the correct member in the database in step 535. Claim information is extracted in step 540 and downloaded and integrated into the database in step 545. The process is completed in step 550.

As in the other processes outlined above, the process of FIG. 5 may be continuous in nature. As new patient encounters are generated, it may be necessary to run the routine of FIG. 5 periodically or continuously to update the patient HSRs.

FIG. 6 is a detail flowchart of the process labeled A.4 in the flowchart of FIG. 1. From the data gathered in the previous steps, medical reports may be generated for each patient (or groups of patients) using the data gathered from the patients, as well as the claim encounters. The database may then be updated with these reports and/or such reports may be generated to the provider.

In step 610, the process of populating the database with medical services information commences. In step 615, selected unsorted records are read from the database. Records may be selected on a number of basis. For example, data for new members or for members with recent medical encounters may be retrieved. Similarly, members for whom no activity has occurred after a predetermined time may be selected. Alternately, records may be selected in a periodic fashion (e.g., alphabetically) so as to go through the patient roster sequentially over a period of time.

In step 620, a determination is made whether a health summary record (HSR) exists for the patient. If no HSR exists for the patient, in step 625, rejected transactions are analyzed for trend groupings. Rejected transactions may include transactions for which no coding exists, or for which coverage is declined. In step 635, a report may be issued to the provider summarizing any trends present in these rejected transactions.

If a health summary record (HSR) exists for the patient, a determination is made in step 630 whether the health summary record is complete. If so, in step 640, the individual member encounter may be sorted by rules based upon any one of the number of codes referred to herein. The data files may then be updated in step 645 with the sorted information. By reducing patient data to code data for each encounter, the size of each patient data file is significantly reduced. The process is complete in step 650.

FIG. 7 is a detail flowchart of the process labeled A.5 in the flowchart of FIG. 1. In this process, each patient may be assigned a health risk “score” based upon the data from the previous steps (HRA, HSR, demographics, claim encounters). A member (patient) may be then assigned to a disease management track.

In step 710, the process of stratifying patients by medical risk grouping commences. In step 720, data based upon the member's demographic information, HRA, HSA, and encounter information is sorted. From that sorted data, a risk stratification score is assigned in step 730. This risk stratification score could be a simple as a three level (low/medium/high) score, of could be made more complex to include specific disease risk levels or codes. Moreover, risk stratification scores may be assigned to each patient for one or more different disease types (e.g., diabetes, heart disease, and the like).

In step 740, a patient may be assigned to a disease management track based upon the risk stratification score level(s). As noted above, a disease management track may help in providing the patient with medical education and help a doctor by suggesting certain tests and office visits to track and control the disease. In step 750, the member, physician, and possible the health care provider may be notified of the resulting score.

This notification process may be suitably tailored for each intended audience. Thus, a patient may received educational information concerning a disease if that patient is identified as being at risk for that disease, whereas a physician may receive risk score information and treatment recommendations. This process includes the creation of special medical alerts, drug trending, diet trending, drug recalls, and patient related news. The process is completed in step 760.

FIG. 8 is a detail flowchart of the process labeled A.6 in the flowchart of FIG. 1. In this process, links may be added for patient-specific immunization, diagnosis and HEDIS parameters to the Health Summary Records. In step 810, the process of creating patient-specific Health Summary Records by medical provider (HSRs) commences.

In step 820, links may be added to the database of the present invention for patient-specific immunization, diagnosis, HEDIS parameters to the Health Summary Records (HSRs). In step 830, the database may then be sorted on the basis of the health care provider involved. In step 840, HSR records may then be sorted alphabetically by patient name. Finally, in step 850, the sorted HSRs may be stored in a separate secure directory for each provider. The process is completes in step 860.

HEDIS (Health Plan Employer Data and Information Set) serves as the clinical performance measurement and data repository for private and federal health-care buyers. HEDIS is a database of quality measures developed by NCQA and used as a standard evaluation tool for health plans. HSR records may then be sorted by provider, alphabetical order, and the like.

FIG. 9 is a detail flowchart of a first part of the process labeled A.7 in the flowchart of FIG. 1. FIG. 10 is a detail flowchart of a second part of the process labeled A.7 in the flowchart of FIG. 1. In this process, data may be gathered from the sources listed above, as well as physician PDA's to generate physician and other reports. The process commences in step 910.

In step 912, claims records are extracted from external systems, typically health care providers (insurance companies, HMOs, PPOs, and the like) and may include patient claim data as well as pharmaceutical claim data. In step 914 authorization records are extracted from these external systems as well. In step 916, referrals records are also extracted. Referrals records may include referrals to specialists and the like.

In step 918, medical surveys, health problems, and health summary updates from physician or other PDAs may be uploaded into the database. In step 920, all of data from the proceeding steps may be sorted based upon predetermined rules. In step 922, the health summary database may be populated or updated based upon the data sort from step 920. In step 924 a physician profile report may be created.

The physician profile report may include an analysis of a physician's patient base and an analysis of disease and demographic trends in that patient base. This physician profile report may be of considerable use to an insurance provider, HMO, PPO, or the like in evaluating physician performance. In the Prior Art, physicians were often unfairly evaluated based upon an averaging of standard physician referrals and testing based upon a large cross-section of physician practices. Individual physicians may be rewarded or penalized based upon the numbers of referrals or tests ordered.

Such practices do not take into account the variations in physician practices, however. Certain patient populations may be more prone to illness based upon age, geographic location, or other parameters unknown. In the present invention, a profile may be created for he physician, and thus identify and allow for increased costs for physicians with practices comprising more sick patients than the norm.

In step 926, a patient demographics transactions report may be generated. This report combines transactions with patient demographics and identifies any trends or correlations. In step 928, demographic information is added to complete each patient record. Personal preferences from patient questionnaires are updated in step 930. Assistive devices are added to patient records via HCPCS codes in step 932. Assistive devices may include medical appliances and the like required to maintain patient health and quality of life.

In step 934, a problems list may be derived from self-reported and transaction based data. Items on the problems list may include various health related problems which would be indicated from transaction data and patient interview data. In step 936, problems identified in step 934 may be sorted into “permanent” or “temporary” categories. Permanent health problems refer to ongoing or chronic conditions (e.g., diabetes, heart disease, allergies, and the like) which follows the patient for life. Temporary conditions may refer to health incidents which are transitory in nature (e.g., broken bones, head cold, flu, and the like) which may not affect a patient's health in the long term.

In step 938, a surgery list is derived form self-reported and transaction data. Surgery list data may include data listing all surgeries performed on each patient. In step 940, each surgery is sorted into permanent and temporary categories, based upon predetermined rules as set forth above. Thus, a surgery for a chronic condition (e.g., heart disease) may be classified as permanent, whereas a surgery for a temporary condition (e.g., appendix removal) may be classified as temporary.

In step 942, an allergies list is collected from self-reported and transaction based records. In step 944 this allergy list may be sorted by date to indicate recent allergies as opposed to older transactions. In this manner, allergy problems which are current and ongoing may be separated from older allergy incidents.

In step 946, a procedure list may be derived from the self-reported and transaction data. This procedure list may be sorted into major and minor categories in step 948 based upon the predetermined rules discussed above. Procedures may include non-surgical medical procedures such as outpatient medical procedures performed in a doctor's office (e.g., biopsy or the like).

In step 950 an encounters list is derived from the transaction data. In step 952, this encounters list may be updated with new encounters and older encounters may be rolled off the list based upon predetermined rules. Thus, for example, chronic or continuing conditions which are important for future diagnosis may be retained in the list (e.g., major medical problems, chronic conditions or allergies, major medical procedures, surgeries or the like) while minor conditions (head cold, broken bone, or the like) may be rolled off. In this manner, the database may be kept at a reasonable size.

In step 954 health screens list is derived from transaction data. The health screens list may indicate which patients should be screened for certain medical conditions, based upon trends noted from the transaction data. Step 956 links FIG. 9 to FIG. 10 where processing continues. In step 958, new health screens are updated and old health screens are rolled off based upon predetermined rules. Thus, for example, a patient may be screened for a particular condition based upon age or health status, and as this age or health status, different screenings may occur (e.g., colo-rectal cancer screening after age 30) and older screenings may be less important.

In step 960, an immunization list is collected from self-reported and transaction based records. In step 962, this immunization list may be sorted based upon age and permanent problem classifications. In step 964, patients and providers may be provided with notifications and alerts regarding immunizations based upon standard immunization rules and procedures. Thus, if a patient has not had required immunizations for a particular age group or within a particular period of time (e.g., tetanus), the patient and/or doctor may be reminded to perform these immunizations.

In step 968, a medications list is collected from self-reporting (e.g., HRA), pharmacy benefit managers, and other transaction based records. In step 970, new medications not previously in the database may be updated to the database and older medications which are not related to a permanent condition may be rolled off the database based upon the predetermined rules. In step 972, checks are made to determine which patients have not complied with their prescribed medical treatments, based on a predetermined set of rules. In step 974, medication non-compliance reports may be generated.

In many instances, patients may see a doctor for a health condition and receive a prescription for medication. However, in traditional practice, there is no technique for insuring that the patient actually purchases and takes the medication. In the system of the present invention, health insurance data (e.g., through pharmacy reimbursement or co-pay data) may be used to confirm that medicine prescribed by the doctor is actually purchased by the patient. If not, a report may be generated indicating that the patient did not follow the prescribed course of action. From such reports, follow-up calls may be made to the patient.

In step 976, medication interaction events are determined, based upon predetermined rules. Medication interactions may include possible interactions between medications prescribed by a doctor and existing medications taken by a patient or allergies to medications that a patient may have. In step 978, medication interaction reports may be generated. From these reports, the doctor and/or patient and/or pharmacist may be notified and warned about possible medication interaction.

In step 980, health care directives may be determined from self reporting answers (e.g., HRAs). Health care directives may include Do Not Resuscitate (DNR) orders requested by the patient, as well as medical power of attorney, living will, organ donation, and other medical directives created by the patient.

Various types of reports may be generated, customized for the intended audience or user. Thus, for example, a first set of reports may be generated for physician use, a second set for health care provider (e.g., insurance company) use, and a third set for patient use. Patients may be able to access their own medical records via secure link or the like. Patient data may include more educational information such that if a patient is diagnosed with a particular illness or disease, appropriate educational information may be provided for that illness or disease in the patient report.

In step 982, a health summary record may be generated based upon transactions and questionnaire answers (e.g., HRAs). The health status report (or Health Summary Record, HSR) may summarize a patient's health status in an abbreviated format.

In step 984, health risk reports may be created. Health risk reports, as the name implies, may indicate what diseases or conditions a patient is at risk for, based upon previous transactions as well as self-reported data. Thus, for example, a patient who smokes and is overweight (from self-reporting data) and has had a history of high blood pressure (from transaction data) may be listed as “at risk” for heart disease (among others).

In step 986, new authorizations and referrals are collected. In step 988, these new authorizations and referrals are updated to the database and older authorizations and referrals are rolled off. Authorizations refers to authorizations for treatments and the like. Referrals refers to referrals to specialists. For chronic or permanent conditions, such authorizations and referrals may not be rolled off, whereas for temporary conditions which have not recurred, such authorizations and referrals may be rolled off after a predetermined period of time.

In step 990, medical guidelines may be created, based upon a specific diagnosis. Diagnoses may be determined from a diagnostic code as input from transaction data. For particular diagnoses, medical guidelines for treatment are available from a number of sources, including the AMA and other specialty disease foundations and organizations. These medical guidelines set forth recommended treatments and medications, as well as provide educational resources for patients. These guidelines may be part of the database of the present invention or may be linked or downloaded from the database of the present invention as illustrated in step 991.

In step 992, standard reports may be distributed. These standard reports may include general data on patient health and health history. In step 994, custom reports may be distributed. As noted above, these custom reports may be generated tailored to physician, patient, or medical provider and may provide different levels of information according to the needs of the report recipient. The process is completed in step 996.

FIG. 11 is a detail flowchart of the process labeled A.8 in the flowchart of FIG. 1. In this process, commencing at step 1101, older or obsolete data may be deleted from the health care provider's files and updated data from step 140 stored, based upon the predetermined rules outlined above. In step 1102, the computer databases of physicians, providers, and the like, are populated with specific health summary information based upon predetermined rules. In step 1102, obsolete or superseded data is deleted from the files. In step 1103, obsolete records are deleted from the data files, in accordance with predetermined rules. An example of an obsolete record is one which documents a temporary medical condition like treatment for a cold, which has exceeded its expiration date. In step 1104, current or revised records are added to the existing files. The process is complete in step 1105.

FIG. 12 is a detail flowchart of the process labeled A.9 in the flowchart of FIG. 1. In this process, commencing at step 1210, Physician PDA (Personal Digital Assistants) may be downloaded with updated patient information when they are “hot synched” with a base station (e.g., PC or the like) in step 1230. Differences between databases 1260, 1280 on PDA 1250 and data stored on different server databases 1220, 1240 may be reconciled and updated in step 1270. New data entered by a physician, for example, may be uploaded onto the databases. Newer data generated by the reporting functions may be downloaded to the PDA. The process is completed in step 1290.

FIG. 13 is a detail flowchart of the process labeled A.10 in the flowchart of FIG. 1. In the process commencing at step 1310, the client (service provider, medical center, doctor) may be evaluated and instructed into how the data of the present invention may be best employed. This process may be performed manually in whole or part. In step 1320, the current state of the client's knowledge and processes is determined. In step 1330, client-specific training programs, including curriculum, syllabus, and instructional class plans are generated for training classes in step 1340.

In step 1350, the effectiveness of the client's medical systems and processes may be evaluated, and the client advised or proposed service change alternatives in step 1360. In the context of FIG. 13, the term “client” may refer to a health care provider (e.g., insurance company, PPO, HMO, and the like), medical practice, or the like. In step 1370, such changes may be implemented and evaluated and the process is complete in step 1380.

FIG. 14 is a detail flowchart of the process labeled A.11 in the flowchart of FIG. 1. In this process, the system of the present invention may be evaluated and refined to improve performance and service, which commences in step 1410. In step 1415, criterion for methods and measurements may be established. In step 1420, baseline performance measurement for each group or provider may be determined.

From these baseline performance measurements and criterion, periodic, ongoing measurements may be performed in step 1425. In step 1430, reports may be created from these periodic measurements and in step 1435, trends analyzed and outlier (or excessively deviant) data points determined for subsequent analysis. In step 1440, statistical methodologies may be applied to draw conclusions from the data of step 1435. From these conclusions, process changes may be formulated and applied in step 1445. In step 1450, the process effectiveness may be continuously remeasured and appropriate changes made in step 1455, with the process ending in step 1460. In the manner of FIGS. 13 and 14, the process of the present invention may be dynamic, rather than static, and may be continually upgraded and improved over time in response to performance data and client needs.

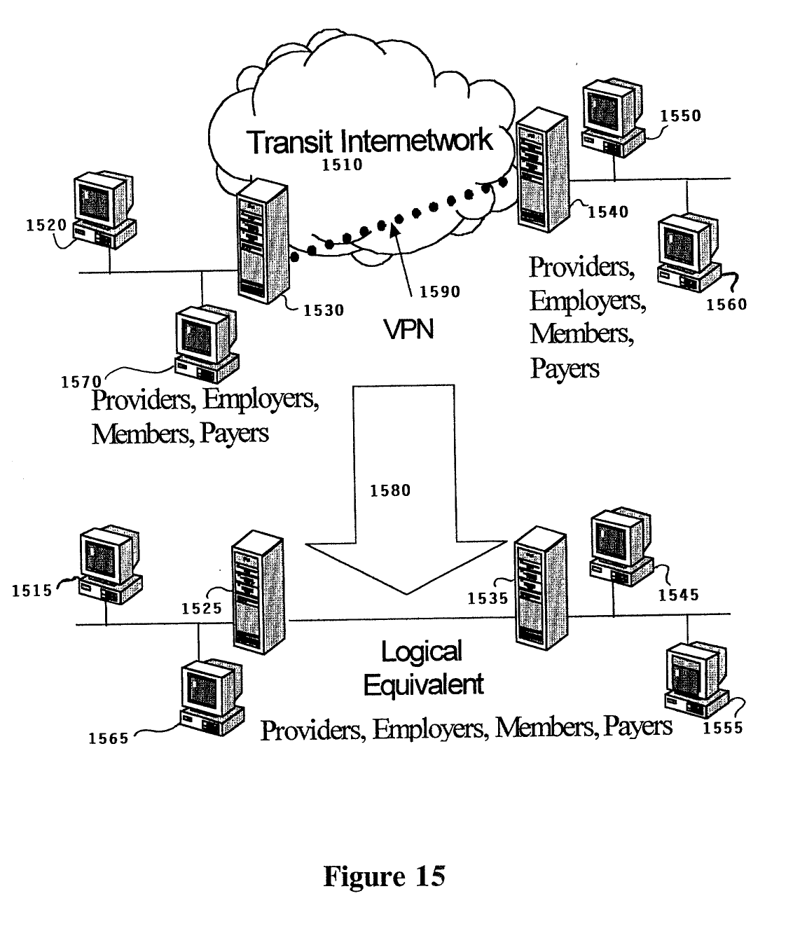

FIG. 15 is a block diagram illustrating various hardware elements of the present invention as coupled by a virtual private network. The upper half of FIG. 15 illustrates a network of PCs 1520, 1570, 1550, and 1560 coupled though servers 1540 and 1540. Servers 1540 and 1530 are by way of example only. Other numbers of servers may be used (and are likely used) in the present invention.

Servers 1530 and 1540 may be coupled through transit internetwork 1510 (e.g., Internet) via a Virtual Private Network (VPN) 1590. VPN 1590 comprises an encrypted datastream between two or more of servers 1530 and 1540. By encrypting the datastream between these servers, a virtual private network is created. Any person trying to intercept packets of data exchanged between servers would see only an encrypted data stream. Thus, security of sensitive patient data is assured. This transit internetwork can occur either within an organization's own proprietary wide or local area network, or as part of the world wide web, or internet.

The lower portion of FIG. 15 illustrates the logical equivalent of the upper portion of FIG. 15, as indicated by arrow 1580. PCs 1515, 1525, 1565, 1545, and 1555 may be coupled together through a network including servers 1525 and 1535. Since the operation of the Virtual Private Network (VPN) is user transparent, individual PCs would “see” the equivalent network as illustrated in the lower half of FIG. 15.

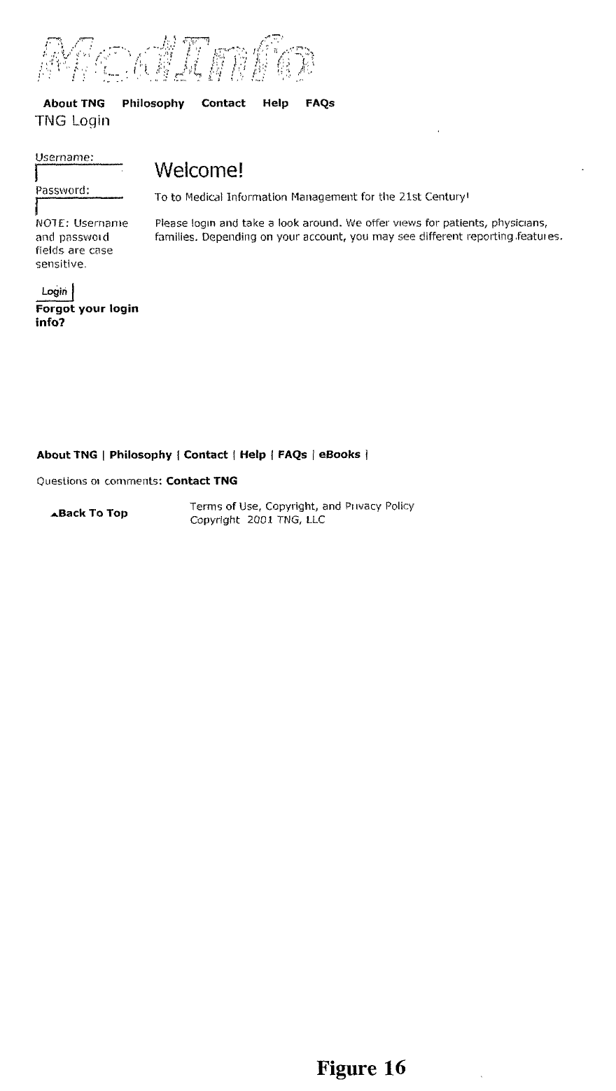

The operation features of the present invention will now be illustrated in conjunction with FIGS. 16-26. FIG. 16 is a screen image of a login procedure for the system of the present invention. Such login screens are known in the art. However, in the present invention, the login screen may be context sensitive. That is to say, depending upon what type of person logs in (Patient, Doctor, Health Care Provider) a different set of menus and reports may be displayed. In the example of FIGS. 16-26, a doctor has logged in.

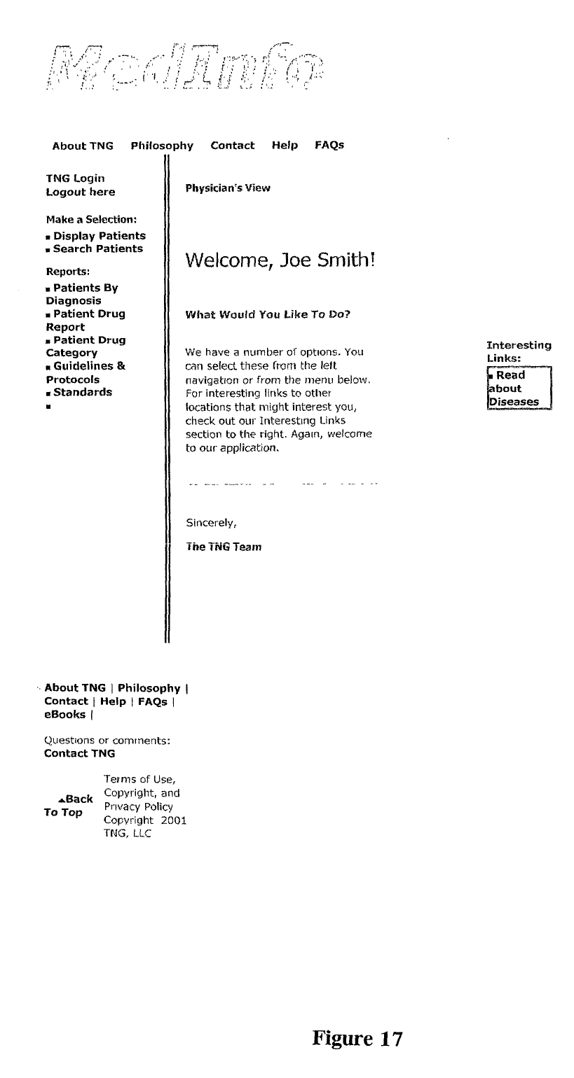

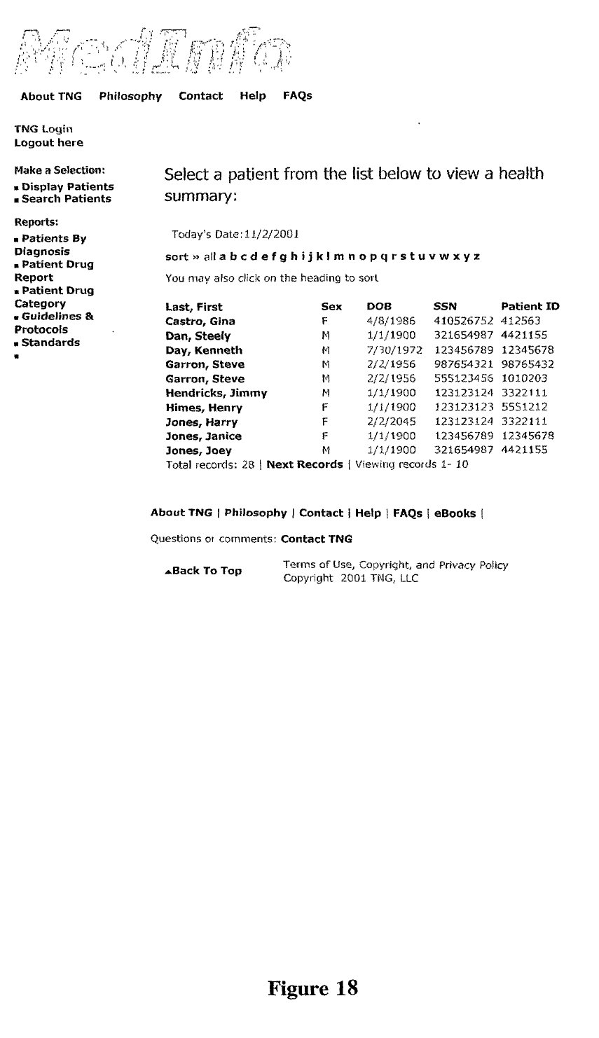

FIG. 17 is a screen image illustrating a welcome page and menu of the present invention. In this example, a doctor has logged in, and thus the menu items displayed to the left of the screen are those reports and features available to a physician. A doctor may display lists of patients, search for a patient, or generate any one of a number of reports. FIGS. 18-26 illustrate these various menu items.

FIG. 18 is a screen image illustrating a selected list of patients from the “display patients” menu. The data illustrated here is sample data for demonstration purposes. An actual patient list would likely be larger and include actual patient data. By clicking on any of the patients listed, a Health Summary Record (HSR) may be displayed.

FIG. 19 is a screen image of a Health Summary Record for a selected patient from the patient list of FIG. 18 (in the Example of FIG. 18, only 10 patients are displayed at a time, so the sample patient name does not appear in the first 10 names of FIG. 18). The Health Summary Record, as described above, includes brief synopsis of a patient's major health records and data.

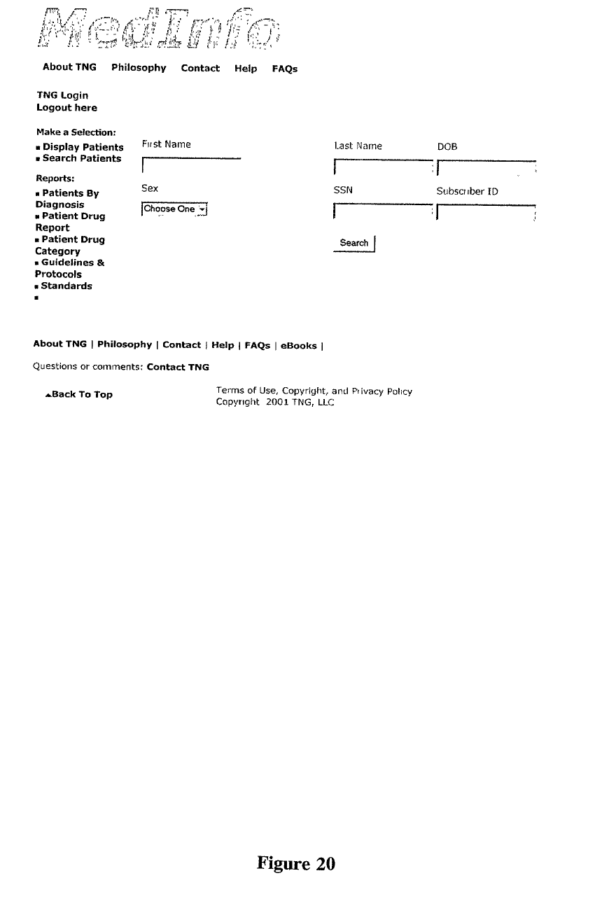

FIG. 20 is a screen image of a patient search engine, the “search patients” feature listed in the menu on the left hand side of the screen. Like most search engines, the patient search engine of FIG. 20 allows a doctor to search for a patient based on name (first or last), social security number, date of birth, or the like. Other searchable data fields may be provided within the spirit and scope of the present invention.

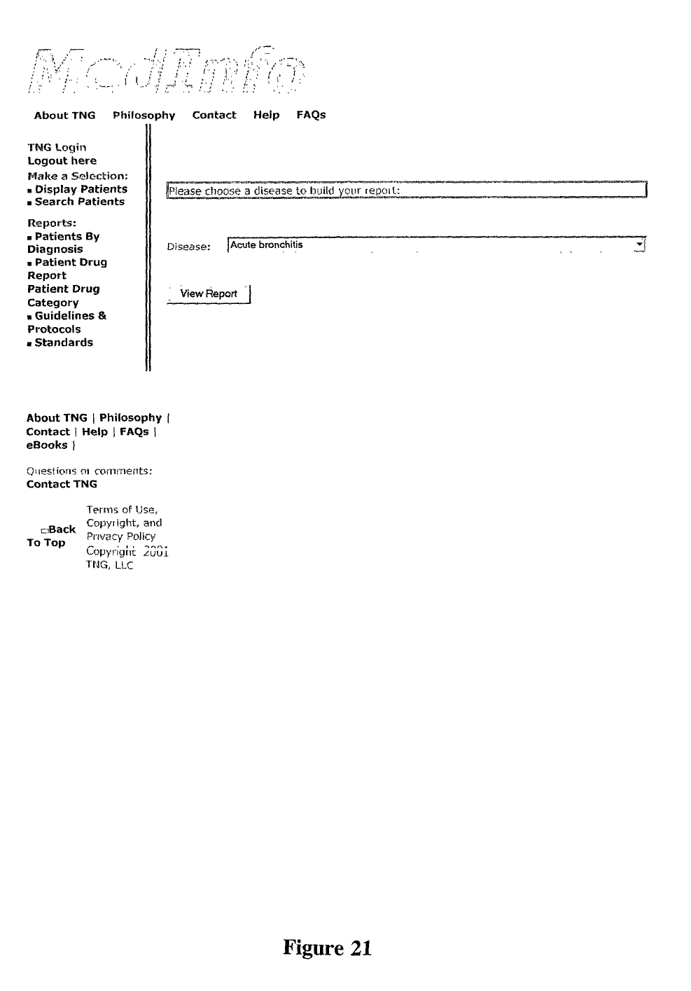

FIG. 21 is a screen image of patients by diagnosis report generation input screen. This feature is also listed on the menu on the left hand side of the screen and may be accessed by clicking on this menu. A doctor may search for a patient based upon a diagnosis of a particular malady. This feature may be useful in tracking spread of disease, for drug recalls, and the like.

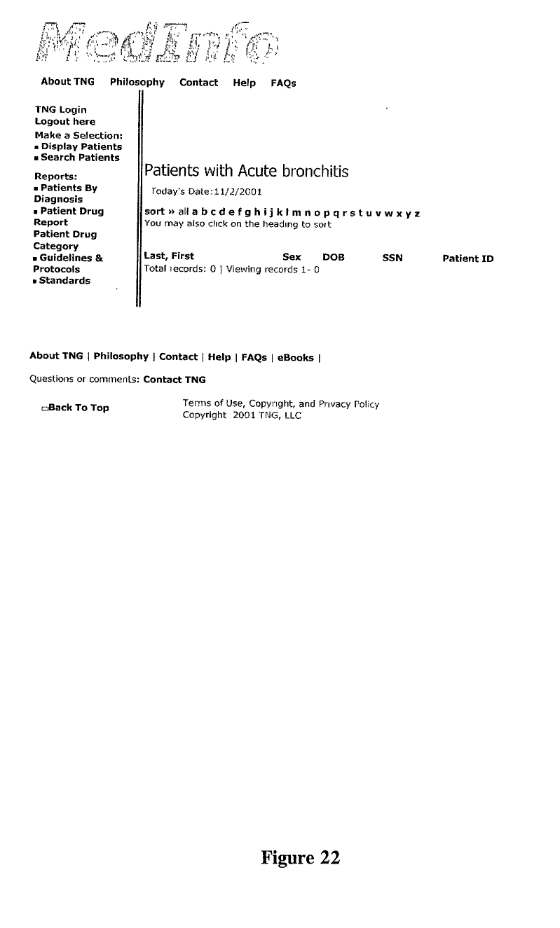

FIG. 22 is a screen image of a result of a patient diagnosis report generated from the input of FIG. 21. In this example, based upon a fairly small sample database, no data was produced.

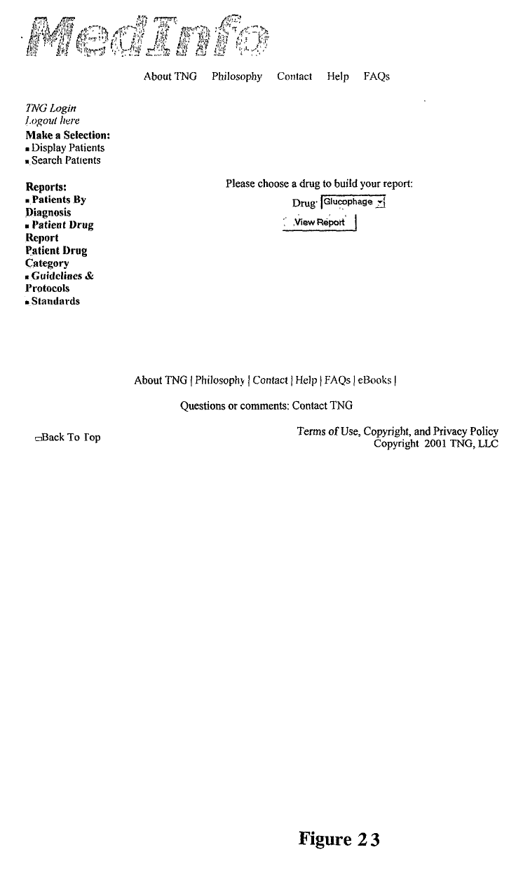

FIG. 23 is a screen image of a patient drug report generation input screen. This feature may also be accessed from the menu on the left hand side of the screen. In this report generator, a doctor may input the name of a drug (in this example, glucophage) and generate a list of patients for whom that drug has been prescribed. This feature may be particularly useful in drug recalls, drug effectiveness monitoring, and the like.

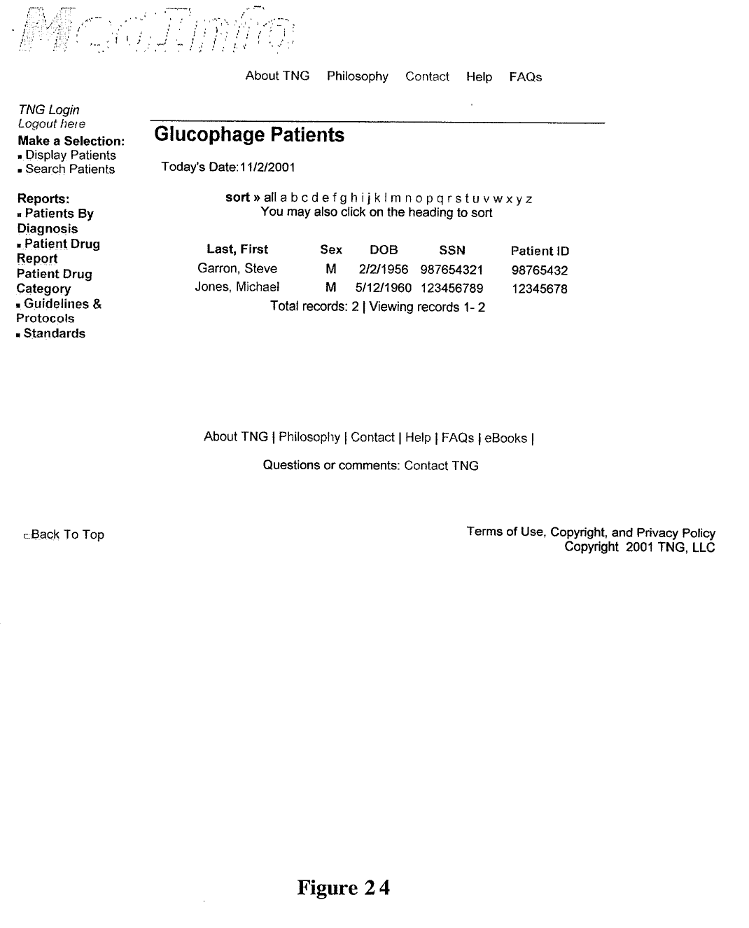

FIG. 24 is a screen image of the results of a patient drug report generated from the input of FIG. 23. In this example, two names from the sample database have been generated in the report. In any of these reports, a physician may click on the patient name to bring up the HSR for that patient.

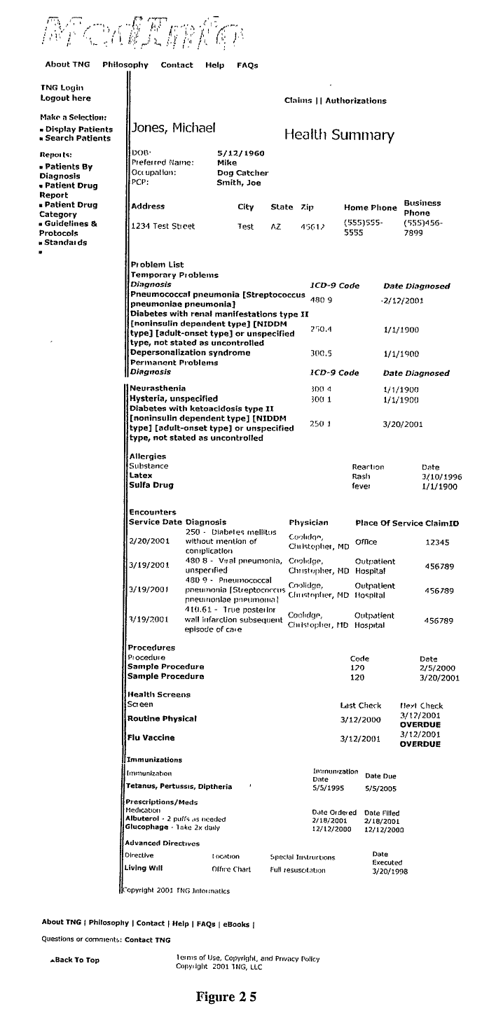

FIG. 25 is a screen image of a Health Summary report (HSR) generated by clicking on one of the name listed in FIG. 24. By clicking on one of the patient names, a complete HSR is generated. In the example shown, the patient has a fairly detailed HSR.

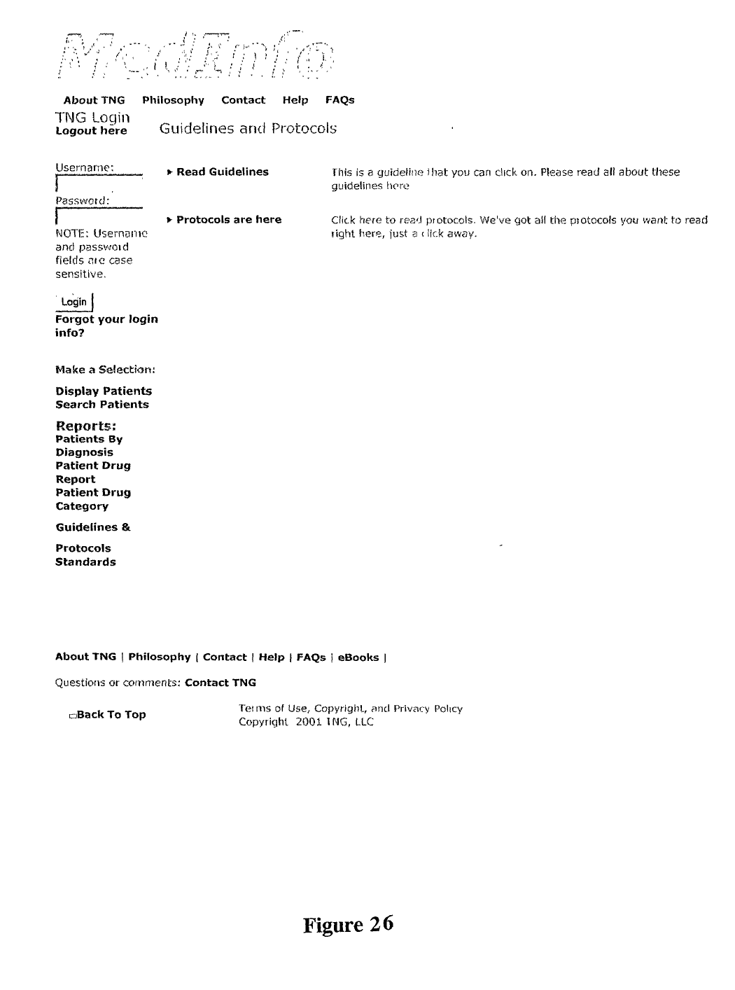

FIG. 26 is a screen image of a input screen for linking to guidelines and protocols. In this screen, a user may log into the system again, and based upon context (doctor, patient, health care provider) different information may be provided. For example, for a doctor login, treatment protocol links may be provided to various existing protocol databases as mentioned above. For a patient login, links may be provided to various patient education databases to educate the patient about disease treatment and prevention.

The Appendix lists various database tables which support the system and its associates processes. In addition to the table list, the content of each table is described in detail, including the specification of the key fields. The actual relationships among the tables themselves have not been specified, but can be readily inferred by someone of ordinary skill in the art, such as someone with reasonable training in medical information systems.

While the preferred embodiment and various alternative embodiments of the invention have been disclosed and described in detail herein, it may be apparent to those skilled in the art that various changes in form and detail may be made therein without departing from the spirit and scope thereof.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

We claim:

1. A health care provider information system comprising:
means for defining a patient population;
means for generating patient interview data;
means for generating patient encounter information;
means for combining patient interview data; and
means for generating medical reports for each patient using patient interview data and patient encounter data.

2. The health care provider information system of claim 1, further comprising:
means for assigning a health risk score to each patient based upon the generated medical report.

3. The health care provider information system of claim 2, further comprising:
means for analyzing patient medical reports and assigning a patient to a disease management track based upon patient medical reports.

4. The health care provider information system of claim 3, wherein said disease management track comprises a medication recommendation program for an attending physician.

5. The health care provider information system of claim 4, wherein said disease management track comprises a treatment recommendation program for an attending physician.

6. The health care provider information system of claim 5, wherein said disease management track comprises an education program for a patient.

7. The health care provider information system of claim 1, further comprising:
means for generating patient reports from the patient medical reports.

8. The health care provider information system of claim 7, wherein said patient reports include medication non-compliance reports generated from patient medication data and prescription claim data to indicate whether a patient has purchased a prescribed medication.

9. The health care provider information system of claim 7, wherein said patient medical reports comprise:
patient temporary condition reports, indicating temporary medical conditions of a patient; and
patient permanent condition reports, indicating permanent conditions of a patient.

10. The health care provider information system of claim 7, wherein said patient medical reports include patient education reports, for educating a patient as to a medical condition.

11. The health care provider information system of claim 7, wherein said patient medical reports include doctor reports summarizing patient medical history and medical condition.

12. The health care provider information system of claim 7, wherein said patient medical reports include medical provider reports summarizing patient medical claim history and medical claim status.

13. The health care provider information system of claim 1, further comprising:
means for downloading patient medical reports to a personal digital assistant;
means for uploading patient data entered by a physician into a personal digital assistant from the personal digital assistant;
and
means for integrating such data into patient medical reports.

14. A method of providing health care information comprising the steps of:
defining a patient population,
generating patient interview data,
generating patient encounter information,
combining patient interview data, and
generating medical reports for each patient using patient interview data and patient encounter data.

15. The method of providing health care information of claim 14, further comprising the steps of:
assigning a health risk score to each patient based upon the generated medical report.

16. The method of providing health care information of claim 15, further comprising the steps of:
analyzing patient medical reports and assigning a patient to a disease management track based upon patient medical reports.

17. The method of providing health care information of claim 16, wherein said disease management track comprises a medication recommendation program for an attending physician.

18. The method of providing health care information of claim 17, wherein said disease management track comprises a treatment recommendation program for an attending physician.

19. The method of providing health care information of claim 18, wherein said disease management track comprises an education program for a patient.

20. The method of providing health care information of claim 14, further comprising the step of:
generating patient reports from the patient medical reports.

21. The method of providing health care information of claim 20, wherein said patient reports include medication non-compliance reports generated from patient medication data and prescription claim data to indicate whether a patient has purchased a prescribed medication.

22. The method of providing health care information of claim 20, wherein the patient medical reports comprise patient temporary condition reports, indicating temporary medical conditions of a patient, and patient permanent condition reports, indicating permanent conditions of a patient.

23. The method of providing health care information of claim 20, wherein said patient medical reports include patient education reports, for educating a patient as to a medical condition.

24. The method of providing health care information of claim 20, wherein said patient medical reports include doctor reports summarizing patient medical history and medical condition.

25. The method of providing health care information of claim 20, wherein said patient medical reports include medical provider reports summarizing patient medical claim history and medical claim status.

26. The method of providing health care information of claim 14, further comprising the steps of:
downloading patient medical reports to a personal digital assistant,
uploading patient data entered by a physician into a personal digital assistant from the personal digital assistant, and
integrating such data into patient medical reports.
